(19) United States
(12) Patent Application Publication
(10) Pub. No.: US 2005/0233098 A1
(43) Pub. Date: Oct. 20, 2005

(54) Ink-jet recording paper

(76) Inventors: Shinichi Asano, Tokyo (JP); Motoko Hiraki, Tokyo (JP)

Correspondence Address: BIRCH STEWART KOLASCH & BIRCH, PO BOX 747, FALLS CHURCH, VA, 22040-0747, US

(21) Appl. No.: 10/514,840

(22) PCT Filed: May 20, 2003
(86) PCT No.: PCT/JP03/06276

§ 371 Date: Feb. 24, 2005

(30) Foreign Application Priority Data
May 21, 2002 (JP) 2002-146460

(51) Int. Cl. B41M 5/40

(52) U.S. Cl. 428/32.34; 428/32.33

(57) ABSTRACT

An ink-jet recording paper which has at least as a surface layer a layer comprising: a copolymer obtained from two monomer compositions (A) and (B) which each comprises a monomer (a) and/or monomer (b) and at least one of which further contains a monomer (c) by polymerizing the monomer composition (A) and then copolymerizing the monomer composition (B), the difference in glass transition temperature between the polymer of the monomer composition (A) and the polymer of the monomer composition (B) being 5° C. or larger, and colloidal silica (2). The paper is improved in gloss in both unprinted areas and printed areas and in suitability for ink-jet recording, e.g., suitability for conveyance. (α-Methyl)styrene. Alkyl(meth)acrylate represented by the formula (1): 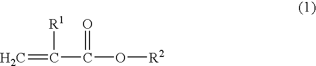
wherein R¹ represents hydrogen etc.; and R² represents a C₁₋₂₂ aliphatic hydrocarbon group. (c) α,β-Unsaturated carboxylic acid and/or salt thereof.

### TECHNICAL FIELD

The present invention relates to an ink-jet printing paper and, more particularly, to an ink-jet printing paper having good gloss in both printed and unprinted areas and also having excellent printability.

### BACKGROUND ART

Ink-jet printers have recently gained general acceptance in various fields on account of their characteristic properties such as low-noise and high-speed operation and capability for multicolor printing.

Such ink-jet printers usually employ a special kind of printing paper, such as woodfree paper designed for easy ink absorption and coated paper with a surface coating of porous pigment.

These printing papers are mostly mat-finish ones with a low surface gloss; however, there is an increasing demand for highly glossy ink-jet printing paper with the recent advance of printing technology which has realized high-quality printing comparable to conventional silver halide photography.

Printing paper with high surface gloss is divided into two classes of coated paper. The first one is produced by coating with a plate pigment, followed by optional calendering. The second one is produced by pressing paper against a mirror-finished hot drum while the coating layer is still wet, thereby transferring the mirror surface to the coating layer. This is known as cast coated paper.

The cast coated paper is superior in surface gloss and surface smoothness to ordinary coated paper finished by supercalendering. Therefore, it produces an outstanding printing effect and hence it finds use exclusively for high-quality printing.

Unfortunately, the cast coated paper mentioned above poses problems when used for ink-jet printing. It shows its high gloss as the mirror-finished surface of the cast coating drum is transferred to the coating layer which is composed of a pigment and a film-forming substance such as adhesive. (See U.S. Pat. No. 5,275,846.) The film-forming substance makes the coating layer less porous, which results in an extremely poor ink absorptivity at the time of ink-jet printing.

One way to tackle this problem or to improve ink absorptivity is to make the coating layer porous for easy ink absorption. To achieve this object, it is necessary to reduce the amount of the film-forming substance. However, reducing the amount of the film-forming substance poses another problem with a decrease in gloss of unprinted areas.

Thus, it has been very difficult to obtain a cast coated paper which meets both requirements for high surface gloss and ink-jet printability.

The present inventors have proposed a possible solution for the above-mentioned problem. That is, the present inventors have succeeded in production of a cast coated paper for ink-jet printing which is superior in both surface gloss and ink absorptivity. The production process includes providing a base paper with an undercoating layer composed mainly of pigment and adhesive. Further, the process includes polymerizing a monomer having an ethylenic unsaturated bond on the undercoating layer, applying a coating solution composed mainly of a copolymer composition having a glass transition point not lower than 40° C. onto the polymer layer, thereby forming a coating layer for casting, and pressing the coating layer against a mirror-finished hot drum while the coating layer is still wet, thereby drying the coating layer. (See Japanese Patent Laid-open No. Hei 7-89220.)

The above-mentioned process yields ink-jet printing paper superior in gloss to conventional ones; however, there still is a demand for further improvement in gloss with the technical advance in ink-jet printers.

### DISCLOSURE OF INVENTION

The present invention was completed in view of the foregoing. It is an object of the present invention to provide an ink-jet printing paper with improvement in gloss of printed and unprinted areas, printing density, ink absorptivity, image quality, and feedability.

In order to achieve the above-mentioned object, the present inventors conducted a series of researches which led to a finding that an ink-jet printing paper excels in gloss of printed and unprinted areas, printing density, ink absorptivity, image quality, and feedability by the printing apparatus. The ink-jet printing paper has a layer formed thereon which contains a copolymer and colloidal silica. The copolymer is obtained by stepwise copolymerization of monomer compositions, each containing a specific monomer such that the resulting polymers differ in glass transition point by 5° C. or more. The present invention is based on this finding.

The present invention is directed to any of the following.
1. An ink-jet printing paper including a base paper and at least one coating layer formed on the base paper, wherein at least the outermost part of the coating layer contains a copolymer (1) and colloidal silica (2), the copolymer (1) being one which is obtained by polymerizing a monomer composition (A) in the first stage and copolymerizing a monomer composition (B) in the second stage, with the resulting polymer of the monomer composition (A) having a glass transition point of Tg_{A} and the resulting polymer of the monomer composition (B) having a glass transition point of Tg_{B} such that the difference between Tg_{A} and Tg_{B} is 5° C. or more, the monomer compositions (A) and (B) each being composed of at least either of two monomer compositions, each containing a monomer (a) defined below and/or a monomer (b) defined below, and a monomer (c) defined below.
(a) Styrene and/or α-methylstyrene.
(b) An alkyl ester of acrylic acid and/or alkyl ester of methacrylic acid represented by the formula (1) below. 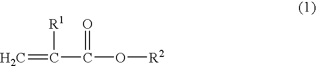
   (where R¹ denotes a hydrogen atom or methyl group, and R² denotes a C₁₋₂₂ saturated or unsaturated linear or branched aliphatic hydrocarbon group.)
(c) An α,β-unsaturated carboxylic acid and/or salt thereof.
   2. An ink-jet printing paper including a base paper and a surface layer formed on the base paper, wherein the surface layer contains a copolymer (1) and colloidal silica (2), the copolymer (1) being one which is obtained by polymerizing a monomer composition (A) in the first stage and copolymerizing a monomer composition (B) in the second stage, with the resulting polymer of the monomer composition (A) having a glass transition point of Tg_{A} and the resulting polymer of the monomer composition (B) having a glass transition point of Tg_{B} such that the difference between Tg_{A} and Tg_{B} is 5° C. or more, the monomer compositions (A) and (B) each being composed of at least either of two monomer compositions, each containing a monomer (a) defined below and/or a monomer (b) defined below, and a monomer (c) defined below.
(a) Styrene and/or α-methylstyrene.
(b) An alkyl ester of acrylic acid and/or alkyl ester of methacrylic acid represented by the formula (1) below. 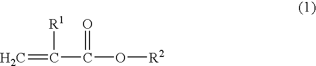
   (where R¹ denotes a hydrogen atom or methyl group, and R² denotes a C₁₋₂₂ saturated or unsaturated linear or branched aliphatic hydrocarbon group.)
(c) An α, β-unsaturated carboxylic acid and/or salt thereof.
   3. An ink-jet printing paper as defined in paragraph 1 or 2 above, wherein the monomer composition (A) and/or the monomer composition (B) further contains a monomer (d) defined below.
(d) A monomer polymerizable with the monomers (a) to (c).
   4. An ink-jet printing paper as defined in any of paragraphs 1 to 3 above, wherein the copolymer is applied in the form of copolymer emulsion having an average particle diameter of 0.02 to 0.15 μm.
   5. An ink-jet printing paper as defined in any of paragraphs 1 to 4 above, wherein the colloidal silica is one which has an average particle diameter of 0.01 to 0.15 μm.
   6. An ink-jet printing paper as defined in any of paragraphs 1 to 5 above, wherein the ratio of the copolymer (1) to the colloidal silica (2) is from 1/9 to 9/1 (by mass of solids).
   7. An ink-jet printing paper as defined in any of paragraphs 1 to 6 above, wherein the surface layer is one which is formed by casting.
   8. An ink-jet printing paper as defined in any of paragraphs 1 to 7 above, which has a surface gloss (75°) not smaller than 30% measured by the method conforming to JIS Z8741.

### BEST MODE FOR CARRYING OUT THE INVENTION

The invention will be described below in more detail.

As mentioned above, the ink-jet printing paper according to the present invention is composed of a base paper and a coating layer formed thereon. The coating layer has at least the outermost part which contains a specific copolymer (1) and colloidal silica (2). Alternatively, the ink-jet printing paper according to the present invention is composed of a base paper and a surface layer formed directly thereon. The surface layer contains a specific copolymer (1) and colloidal silica (2).

According to the present invention, the outermost part of the coating layer contains a specific copolymer (1) composed of the monomers (a) to (d). The copolymer is not specifically restricted in the ratio of copolymerization of these monomers. However, the ratio should be determined in consideration of printability required of the ink-jet printing paper.

The monomer (a) mentioned above is styrene and/or α-methylstyrene. The ratio of copolymerization of these monomers should be 5 to 95 wt %, particularly 30 to 90 wt %, of the total amount of the monomer composition (A) and the monomer composition (B). If this ratio is less than 5 wt %, the printing paper would be poor in gloss-after printing. If this ratio is more than 95 wt %, the printing paper would be poor in light fastness.

The monomer (b) mentioned above is an alkyl ester of acrylic acid and/or alkyl ester of methacrylic acid represented by the formula (1) above. It should preferably be one which contains an acrylic ester so that the printing paper has balanced feedability and image resolution.

In this case, the alkyl group of the ester should be a C₁₋₂₂ saturated or unsaturated linear or branched aliphatic hydrocarbon group. It includes, for example, methyl, ethyl, n-butyl, iso-butyl, t-butyl, pentyl, 2-ethylhexyl, lauryl, and stearyl groups.

Typical examples of the (meth)acrylic ester include methyl (meth)acrylate, ethyl (meth)acrylate, butyl (meth)acrylate, 2-ethylhexyl (meth)acrylate, lauryl (meth)acrylate, and stearyl (meth)acrylate. They may be used alone or in combination with one another.

The monomer (b) mentioned above is not specifically restricted in the ratio of copolymerization. The ratio of copolymerization should be 0.5 to 95 wt %, preferably 1 to 85 wt %, based on the total amount of the monomer compositions (A) and (B) mentioned above. If this ratio is less than 0.5 wt %, the printing paper would cause dull color development. If this ratio is more than 95 wt %, the printing paper would give images with a low resolution.

The monomer (c) mentioned above is an α,β-unsaturated carboxylic acid and/or salt thereof. It includes, for example, acrylic acid, methacrylic acid, maleic acid, fumaric acid, itaconic acid, crotonic acid, and their sodium salt, potassium salt, and ammonium salt. They may be used alone or in combination with one another. Of these examples, sodium salt or ammonium salt of acrylic acid or methacrylic acid is desirable from the standpoint of cost reduction and good adhesion to the base paper.

The monomer (c) mentioned above is not specifically restricted in the ratio of copolymerization. The ratio of copolymerization should be 0.5 to 30 wt %, preferably 1 to 20 wt %, based on the total amount of the monomer compositions (A) and (B) mentioned above. If this ratio is less than 0.5 wt %, the printing paper would give images with a low resolution. If this ratio is more than 30 wt %, the printing paper would be poor in water resistance.

The monomer (d) mentioned above is a monomer polymerizable with the monomers (a) to (c) mentioned above. It is an optional component that can be used in any amount without adverse effect on the present invention. It includes, for example, acrylamide, methacrylamide, N-hydroxymethylacrylamide, 2-hydroxyethylacrylate, methoxypolyethylene glycol methacrylate, vinyl acetate, acrylonitrile, methylenebisacrylamide, polyethylene glycol diacrylate, divinylbenzene, trimethylolpropane triacrylate, styrenesulfonic acid and salt thereof, and 2-acrylamide-2-methylpropanesulfonic acid and salt thereof.

The ratio of copolymerization of the monomer (d) should be equal to or less than 20 wt %, preferably 0.1 to 15 wt %, based on the total amount of the monomer compositions (A) and (B) mentioned above.

According to the present invention, the monomer compositions (A) and (B) are formed from the monomers (a) to (c) and the optional monomer (d) by mixing in any manner. They should have specific compositions so that the monomer composition (A) gives a polymer having a glass transition point of Tg_{A} and the monomer composition (B) gives a polymer having a glass transition point of Tg_{B}, with the difference between Tg_{A} and Tg_{B} being 5° C. or more. The result of failing to meet this requirement is that the printing paper (which has been coated with the coating material according to the present invention) is poor in feedability by the printing apparatus. The difference between the two glass transition points should be 10° C. or above for better feedability.

To meet the requirement just mentioned above, it is necessary that the ratio of copolymerization of the monomer (c) in the monomer composition (A) and the ratio of copolymerization of the monomer (c) in the monomer composition (B) should differ by at least 1 wt %, preferably 2 wt % or more.

It does not matter whether either of Tg_{A} and Tg_{B} is higher or lower than the other. However, it is desirable that Tg_{A} be lower than Tg_{B}, so that the coating layer has a good gloss, ink absorptivity, and film strength, and the printing paper has good feedability.

Incidentally, the above-mentioned glass transition points are those which have been calculated according to the Fox formula given below.

$$\frac{1}{Tg} = \frac{a}{{Tg}_{a}} + \frac{b}{{Tg}_{b}} + \frac{c}{{Tg}_{c}} + \frac{d}{{Tg}_{d}}$$

(where Tgₐ to Tg_{d} denote respectively the glass transition points (K) of the respective homopolymers of the monomers (a) to (d); and a to d denote respectively the ratio of amount of the respective copolymers of the monomers (a) to (d), with a+b+c+d=1.)

The glass transition point Tg_{A} of the polymer of the monomer composition (A) should be in the range of 0 to 200° C., preferably 20 to 180° C. The glass transition point Tg_{B} of the polymer of the monomer composition (B) should be in the range of 0 to 200° C., preferably 20 to 180° C. If the glass transition point is lower than 0° C., the coating layers facing each other tend to stick together due to poor thermal stability. If the glass transition point is higher than 200° C., the coating layer would be inhomogeneous.

According to the present invention, the monomer compositions (A) and (B) as the raw materials of the copolymers (emulsions) should be composed of the monomers (a) to (d) in the ratio shown in Table 1 below, on the assumption that the total amount of the monomer compositions is 100 wt %. The present invention is not restricted in the ratio shown in Table 1.

TABLE 1

| | Monomer composition (A) | | Monomer composition (B) | |
|---|---|---|---|---|
| (a) | 5-95 | wt % | 5-95 | wt % |
| (b) | 1-95 | wt % | 0-85 | wt % |
| (c) | 0-10 | wt % | 1-30 | wt % |
| (d) | 0-20 | wt % | 0-20 | wt % |
| Total | 100 | wt % | 100 | wt % |

According to the present invention, the copolymer (emulsion) should be prepared from the monomer composition (A) and the monomer composition (B). The former accounts for 10 to 90 wt %, preferably 20 to 60 wt %, and the latter accounts for 90 to 10 wt %, preferably 80 to 40 wt %, on the assumption of that the total amount of the monomer compositions constituting the copolymer (emulsion) is 100 wt %. If the amount of the monomer composition (A) or (B) is less than 10 wt % or more than 90 wt %, the printing paper of the present invention will be poor particularly in feedability.

According to the present invention, the above-mentioned copolymer is obtained by polymerizing the monomer composition (A) in the first stage and then polymerizing the monomer composition (B) in the second stage.

No specific restrictions are imposed on the method and condition of polymerization to give the copolymer. Ordinary emulsion polymerization, for example, may be employed in such a way that the resulting copolymer emulsion contains 20 to 50 wt % of solids and has an average particle diameter of 0.02 to 0.15 μm.

If the average particle diameter is smaller than 0.02 μm, the printing paper will have a low gloss in printed areas. If the average particle diameter is larger than 0.15 μm, the printing paper will not give a clear image.

Some typical methods for polymerization are listed in the following. The first method includes emulsifying a portion of the monomer composition (A) in water containing an emulsifier dissolved therein, continuously adding dropwise the remainder of the monomer composition (A) and a radical polymerization initiator, thereby performing emulsion polymerization, and continuously adding dropwise the monomer composition (B) and a radical polymerization initiator, thereby giving the desired copolymer emulsion. The second method includes polymerizing the monomer composition and a radical polymerization initiator all at once at the time of polymerizing the monomer composition (A) and subsequently polymerizing the monomer composition (B) all at once (for emulsion polymerization by simultaneous reaction). The third method includes feeding the reaction system with the monomer compositions (A) and (B) stepwise separately. Of these three methods, the first one is desirable from the standpoint of stable polymerization and easy control of reaction heat and particle size. In all the three methods, it is possible to feed the reaction system with the monomer compositions which have previously been emulsified with an emulsifier. Incidentally, the polymerization temperature should preferably be 40 to 95° C. The copolymer emulsion obtained by any of the above-mentioned methods will usually differ in particle structure (e.g., core-shell structure or sea-island structure).

No specific restrictions are imposed on the emulsifier used for emulsion polymerization. Any known emulsifier is acceptable. However, an anionic emulsifier is desirable to effectively control the average particle diameter of the copolymer emulsion. Examples of the anionic emulsifier include sulfuric acid (higher alcohol) ester salt, alkylbenzenesulfonate, aliphatic sulfonate, dialkylsulfosuccinate salt, alkylnaphthalene sulfonate, alkyldiphenyl ether disulfonate, polyoxyethylene alkyl ether sulfate ester salt, polyoxyethylene alkyl phenyl ether sulfate ester salt, arylalkyl phenyl polyethylene oxide sulfate ester salt, and arylalkyl sulfosuccinate diester salt.

The anionic emulsifier may also be used in combination with a nonionic emulsifier or a polymeric emulsifier, the former including polyoxyethylene alkyl phenyl ether, polyoxyethylene alkyl ether, and polyoxyethylene alkyl ester, the latter including sodium polystyrenesulfonate and polyvinyl alcohol sulfonate.

No specific restrictions are imposed on the radical polymerization initiator used for emulsion polymerization. Any known ones are acceptable. They include peroxides, such as hydrogen peroxide, ammonium persulfate, sodium persulfate, and potassium persulfate, a redox initiator to be combined with any of the peroxides, and an azo-initiator, such as 2,2-azobis(aminodipropane)hydrochloride. It is also possible to optionally use a molecular weight modifier such as dodecyl mercaptan, dialkylamine, and allyl alcohol.

According to the present invention, the copolymer (1) mentioned above is incorporated with the colloidal silica (2). No specific restrictions are imposed on the colloidal silica (2) so long as it has an average particle diameter of 0.01 to 0.15 μm, preferably 0.015 to 0.12 μm, more preferably 0.02 to 0.10 μm. Excessively fine colloidal silica with an average particle diameter smaller than 0.01 μm adversely affects ink absorptivity. Excessively coarse colloidal silica with an average particle diameter larger than 0.15 μm adversely affects image clarity.

The colloidal silica (2) mentioned above is in the form of aqueous colloid solution in which spherical silica is dispersed. Silica particles in the colloid solution have negatively charged silanol groups on their surface. The colloid solution is anionic when neutralized with a base such as sodium hydroxide, sodium silicate, and organic amine.

The anionic colloidal silica may be selected from commercial ones, such as “Silicadol” from Nippon Chemical Industrial Co., Ltd., “Adelite AT” from Asahi Denka Co., Ltd., “Catalloid” from Catalysts & Chemicals Ind. Co., Ltd., and “Snowtex” from Nissan Chemical Industries, Ltd. An aqueous dispersion with a pH value of 8 to 12 and a concentration of 20 to 50 wt % is desirable for stable miscibility with the copolymer emulsion.

The present invention does not specifically restrict the ratio of the copolymer (1) to the colloidal silica (2). The ratio (in terms of weight of solids) may range from 1/9 to 9/1, preferably from 3/7 to 7/3, more preferably from 3/7 to 5/5. The copolymer in a ratio more than 90 wt % adversely affects image clarity, and the copolymer in a ratio less than 10 wt % adversely affects gloss.

No specific restrictions are imposed on the ratio (X)/(Y), where (X) stands for the average particle diameter of the emulsion of the copolymer (1) and (Y) stands for the average particle diameter of the colloidal silica (2). However, this ratio should be from 0.5 to 5.0, preferably from 0.6 to 4.0, more preferably from 0.7 to 3.5, for better image clarity and gloss.

Incidentally, the average particle diameters of the copolymer emulsion and colloidal silica are measured with a light scattering electrophoresis photometer (Model ELS-800, from Otsuka Electronics Co., Ltd.).

As mentioned above, the ink-jet printing paper of the present invention is composed of a base paper and a coating layer formed thereon, and at least the outermost part of the coating layer or the coating layer as a whole contains the copolymer (1) and the colloidal silica (2). The mixing ratio of these components is not specifically restricted; however, it is usually from 10 to 100 wt %, preferably from 30 to 100 wt %, of the total amount of the layers containing these components.

The outermost part of the coating layer may contain, in addition to the copolymer and anionic colloidal silica mentioned above, an adhesive which is commonly used in the field of coated paper. The adhesive may be a water-soluble resin such as polyvinyl alcohol, modified polyvinyl alcohol (e.g., cation-modified polyvinyl alcohol and silyl-modified polyvinyl alcohol), casein, soybean protein, synthetic protein, starch, and cellulose derivatives (e.g., carboxymethyl cellulose and methyl cellulose), conjugated diene polymer (e.g., styrene-butadiene copolymer and methacrylate-butadiene copolymer), aqueous dispersible resin (e.g., ethylene-vinyl acetate copolymer and other vinyl copolymers), aqueous acrylic resin, aqueous polyurethane resin, and aqueous polyester resin. The adhesive may be used in any amount not harmful to the copolymer and the colloidal silica.

The outermost part of the coating layer may be incorporated with, in addition to the colloidal silica (2) mentioned above, any pigment, such as colloidal silica (excluding the one mentioned above), amorphous silica, aluminum oxide, zeolite, and synthetic smectite, for improvement in gloss, clarity, and ink absorptivity. These pigments should have an average particle diameter in the range of from 0.01 to 5 μm, preferably from 0.05 to 1 μm. Those with an average particle diameter smaller than 0.01 μm do not fully contribute to ink absorptivity. Those with an average particle diameter larger than 5 μm will adversely affect gloss and printing density.

For improved gloss and ink absorptivity, the amorphous silica should preferably be one whose primary particles have an average particle diameter of 3 to 40 nm and whose secondary particles have an average particle diameter of 10 to 300 nm.

The pigment, colloidal silica, and copolymer emulsion mentioned above should preferably have the same ionicity for their high miscibility.

The outermost part of the coating layer may be formed from a coating solution incorporated with various auxiliaries for adjustment of whiteness, viscosity, and flowability. Such auxiliaries include pigment, anti-foam agent, dye, fluorescent whitening agent, anti-static agent, antiseptic, dispersing agent, and thickener, which are commonly used for paper coating solution and ink-jet printing paper. The coating solution may also be incorporated with a cationic resin to improve ink dye anchorage.

The outermost part of the coating layer may be formed by casting (which employs a hot mirror-finished surface) or film transfer. In this case, the coating solution may be incorporated with a release agent for easy release from the cast dram or film. The release agent is an ordinary one which is commonly used for production of coated printing paper and cast paper. Its typical examples include polyolefin wax (e.g., polyethylene wax and polypropylene wax), alkali salt of higher fatty acid (e.g., calcium stearate, zinc stearate, potassium oleate, and ammonium oleate), silicone compounds (e.g., silicone oil and silicone wax), fluorine compounds (e.g., polytetrafluoroethylene), lecithin, and higher fatty acid amide.

The ink-jet printing paper of the present invention is not specifically restricted in base paper. It may be produced from any base paper (acid paper and neutralized paper), synthetic resin film sheet, and laminate paper, which are commonly used for coated paper.

However, in the case where the casting method or film transfer method is used to form the outermost part of the coating layer, a permeable base paper or a permeable resin film sheet is desirable.

The base paper mentioned above is composed mainly of wood pulp and optional filler (or pigment). The wood pulp includes chemical pulp, mechanical pulp, and regenerated pulp. These types of pulp should have their freeness properly adjusted by the beating machine for adequate paper strength and paper-making properties.

The wood pulp is not specifically restricted in freeness. An adequate value of freeness is from 250 to 550 mL (according to CSF: JIS P8121).

Another desirable type of wood pulp is chlorine-free pulp, such as ECF (Element Chlorine-Free) pulp and TCF (Total Chlorine-Free) pulp.

The optional pigment is intended to impart opacity or to adjust ink absorptivity. It includes, for example, calcium carbonate, calcined kaolin, silica, and titanium oxide. The amount of the pigment should preferably be 1 to 20 wt % of the total weight of base paper. Excess pigment will adversely affects paper strength.

The auxiliaries include sizing agent, fixing agent, paper strength improver, cationizing agent, yield improver, dye, and fluorescent whitening agent.

The base paper mentioned above may have its surface strength and size fastness properly adjusted by coating and/or impregnation with starch, polyvinyl alcohol, cationic resin, etc. in the size press step of paper making. The size fastness should preferably be approximately 1 to 200 seconds. Base paper with an excessively low size fastness is subject to wrinkling at the time of coating. Base paper with an excessively high size fastness is poor in ink absorptivity, which leads to strike through and curling or cockling after printing. The base paper is not specifically restricted in basis weight. A desirable basis weight ranges from 20 to 400 g/m².

The ink-jet printing paper of the present invention may have a coating layer including more than one part. In this case, the outermost part of the coating layer is formed from the copolymer (1) and the colloidal silica (2) mentioned above, and an undercoating layer may be formed between the base paper and the coating layer. This undercoating layer increases the amount and speed of ink absorption. The coating layer and the undercoating layer each may be composed of more than one part.

The undercoating layer should preferably contain a pigment and an adhesive as major ingredients.

The pigment to be added to the undercoating layer may be any of the following materials which are commonly used in the field of coated paper.

Kaolin, clay, calcined clay, amorphous silica, synthetic amorphous silica, colloidal silica, zinc oxide, aluminum oxide, aluminum hydroxide, calcium carbonate, satin white, aluminum silicate, alumina, zeolite, synthetic zeolite, sepiolite, smectite, synthetic smectite, magnesium silicate, magnesium carbonate, magnesium oxide, diatomaceous earth, styrene plastic pigment, hydrotalcite, urea resin plastic pigment, and benzoguanamine plastic pigment. They may be used alone or in combination with one another. Of these materials, amorphous silica, alumina, and zeolite are desirable because of their high ink absorptivity.

The adhesive to be added to the undercoating layer may be any of the following materials which are commonly used in the field of coated paper.

Proteins (including casein, soybean protein, and synthetic protein), starch (including starch and oxidized starch), polyvinyl alcohols (including polyvinyl alcohol, cationic polyvinyl alcohol, and modified polyvinyl alcohol such as silyl-modified polyvinyl alcohol), cellulose derivatives (including carboxymethyl cellulose and methyl cellulose), conjugated diene polymer latex (including styrene-butadiene copolymer and methacrylate-butadiene copolymer), and vinyl polymer latex (including acrylic polymer latex and ethylene-vinyl acetate copolymer latex). They may be used alone or in combination with one another.

The amount of the adhesive is usually from 1 to 100 parts by weight, preferably from 2 to 50 parts by weight, for 100 pars by weight of the pigment.

Moreover, the undercoating layer may be incorporated with, in addition to the pigment and adhesive mentioned above, any of the following auxiliaries and dyes which are commonly used in production of coated paper.

Dispersing agent, thickening agent, anti-foaming agent, anti-static agent, antiseptic, fluorescent dye, and coloring agent.

Also, the undercoating layer should preferably be incorporated with a cationic compound to fix the dye components in the ink-jet printing ink. The cationic compound contributes to gloss. A probable reason for this is that the cationic compound coagulates the coating layer (which contains the colloidal silica (2) mentioned above) to be formed thereon, thereby preventing the coating solution for the coating layer from penetration.

The cationic compound includes, for example, cationic resin and low-molecular weight cationic compound (such as cationic surface active agent). A cationic resin is desirable for increased printing density. Incidentally, the cationic compound should preferably be used in the form of water-soluble resin or emulsion.

The cationic resin may be used in the form of crosslinked insoluble particulate cationic organic pigment. This cationic organic pigment may be prepared by copolymerizing (for crosslinking) polyfunctional monomer during polymerization for the cationic resin. It may also be produced by crosslinking a cationic resin having reactive functional groups (such as hydroxyl group, carboxyl group, amino group, and acetoacetyl group) with the help of heat or radiation and an optical crosslinking agent. The cationic compound (particularly cationic resin) mentioned above may play a role of adhesive.

Examples of the cationic compound mentioned above include the following.
(1) Polyalkylene polyamines or derivatives thereof, such as polyethylene polyamine and polypropylene polyamine.
(2) Acrylic resin having a secondary amine group, a tertiary amine group, or a quaternary ammonium group.
(3) Polyvinylamines and polyvinylamidines.
(4) Dicyan cationic resin exemplified by dicyandiamide-formalin polycondensate.
(5) Polyamine cationic resin exemplified by dicyandiamide-diethylenetriamine polyocondensate.
(6) Epichlorohydrin-dimethyamine addition polymer.
(7) Dimethyldiallylammonium chloride-SO₂ copolymer.
(8) Diallylamine salt-SO₂ copolymer.
(9) Dimethyldiallylammonium chloride polymer.
(10) Allylamine salt polymer.
(11) Dialkylaminoethyl (meth)acrylate quaternary salt polymer.
(12) Acrylamide-diallylamine salt copolymer.

These cationic compounds also produce the effect of improving the water-resistance of printed images.

The amount of the cationic compound to be incorporated into the undercoating layer is usually 1 to 100 pbw, preferably 5 to 50 pbw, for 100 pbw of the pigment contained in the undercoating layer. The cationic compound in an excessively small amount will not increase the density and water resistance of printed images. The cationic compound in an excessively large amount will reduce print density and cause feathering.

The coating solution for the undercoating layer is prepared so that it contains the above-mentioned components in an amount of 5 to 50 wt % (as solids). Then, it is applied to a base paper so that the amount of coating (on dry basis) is about 2 to 100 g/m², preferably 5 to 50 g/m², and more preferably 10 to 20 g/m².

The coating solution in an excessively small amount does not fully produce its effect but even produces adverse effects such as feathering of printed images, poor gloss, cockling after printing (due to excess ink absorption), and indentation by the printer's feeding rolls or gears. The coating solution in an excessively large amount produces adverse effects such at low print density, weak coating layer (or undercoating layer), dusting, and scratching.

The method of coating is not specifically restricted; coating (and ensuing drying) may be accomplished by using any known coating apparatus such as blade coater, air knife coater, roll coater, brush coater, Champflex coater, bar coater, lip coater, gravure coater, and curtain coater.

According to the present invention the outermost part of the coating layer contains the specific copolymer (1) and the colloidal silica (2) as mentioned above. It is formed by applying a coating solution containing these components onto the undercoating layer (mentioned above) or directly onto a base paper.

Application of the coating solution onto the undercoating or base paper is followed by drying and surface smoothing to impart gloss. Although surface smoothing may be accomplished by supercalendering, it is desirable to employ casting for high gloss and good ink-jet printability. The term “casting” embraces ordinary casting by means of a mirror-finish drum and film transfer.

Ordinary casting is a method of imparting a smooth glossy surface to the coating layer. This method includes drying a wet coating layer on a smooth surface in such a way that smoothness is transferred to the coating layer. The smooth surface may be a casting drum of metal, plastic, or glass with a mirror-finished surface. The smooth surface may also be any of mirror-finished metal plate, plastic sheet, plastic film, and glass plate.

According to the present invention, any of the following methods can be used to form the outermost part of the coating layer by casting that employs a heated mirror-finished drum.
(1) Wet casting method of applying the coating solution directly onto a base paper or onto an undercoating layer formed on a base paper, and pressing the coating layer (in wet state) against a hot mirror-finished drum for drying.
(2) Rewet casting method of rewetting the previously dried coating layer and pressing the wet coating layer against a hot mirror-finished drum for drying.
(3) Gel casting method.
(4) Precasting method of directly coating a hot mirror-finished drum with the coating solution and pressing (for drying) the drum against a base paper or an undercoating layer on a base paper.

Incidentally, the hot mirror-finished drum used in the above-mentioned methods should be kept at 50 to 150° C., preferably 70 to 120° C.

Also, either of the following two methods can be used to form the outermost part of the coating layer by film transfer.
(1) The first method of applying the coating solution onto a base paper or onto an undercoating layer formed on a base paper, placing a smooth film or sheet on the coating layer (still in wet state), drying the coating layer, and peeling off the smooth film or sheet.
(2) The second method of applying the coating solution including the specific copolymer emulsion (1) and the colloidal silica (2) onto a smooth film or sheet, thereby forming the coating layer, pressing a base paper (with or without an undercoating layer) against the coating layer in wet state (or while the base paper or the undercoating layer thereon is still wet), and peeling off the smooth film or sheet after drying.

The smooth film or sheet should have a surface roughness (Ra defined by JIS B0601) no higher than 0.5 μm, preferably no higher than 0.05 μm.

Casting that employs a hot mirror-finished surface is preferable to casting by film transfer because of its better smoothness and favorable productivity and production cost.

The amount of the coating solution (for the outermost part of the coating layer) is 1 to 30 g/m², preferably 2 to 20 g/m², more preferably 3 to 15 g/m², on dry solids basis. An amount less than 1 g/m² is not enough for sufficient print density and gloss. Coating with an amount more than 30 g/m² does not produce any additional effect but needs a large amount of energy for drying. Incidentally, the cast finishing may be followed by smoothing with supercalendering.

Coating for the above-mentioned casting method may be accomplished by using any of the following known coating machines. Blade coater, air knife coater, roller coater, brush coater, Champlex coater, bar coater, and gravure coater.

As mentioned above, the present invention provides an ink-jet printing paper which is characterized by high surface gloss. The surface gloss (75°) measured according to JIS Z8741 should be no lower than 30%, preferably no lower than 40%, and more preferably no lower than 65%. The upper limit is 95%, although not specifically restricted. The glossy ink-jet printing paper gives high-quality images comparable to photographs.

### EXAMPLES

The invention will be described in more detail with reference to the following examples and comparative examples, which are not intended to restrict the scope thereof. In the following examples, “%” and “parts” mean “wt %” and “parts by weight”, respectively.

[1] Preparation of Base Paper

A base paper (with a basis weight of 120 g/m²) was prepared from a material composed of the following components by using a Fourdrinier machine.
Wood pulp (LBKP, freeness 500 mL, CSF): 100 parts
Calcined kaolin (“Ansilex” from Engelhard Corporation): 9 parts.
Commercial sizing agent (PM356, from Arakawa Chemical Industries, Ltd.): 0.05 parts.
Aluminum sulfate: 1.5 parts.
Wet-strength agent (“WS570” from Japan PMC Corporation): 0.5 parts.
Starch: 0.75 parts.

The resulting base paper was found to have a Stöckigt sizing degree of 10 seconds. This base paper was used in the following examples and comparative examples.

[2] Preparation of Copolymer Emulsion

### Preparation Example 1

A reactor equipped with a stirrer, thermometer, reflux condenser, dropping funnel, and nitrogen inlet was charged with the following components.
Deionized water: 641 parts.
Polyoxyethylene (n=5) lauryl ether sulfate ester sodium salt (as an emulsifier): 9 parts.
Monomer composition (A) shown in Table 2: 10 parts.

The content in the reactor was heated to 75° C. under a nitrogen stream. The reactor was supplied with 10 parts of an aqueous solution containing 1.5 parts of ammonium persulfate in deionized water, with the content in the reactor kept stirred at 75° C. The polymerization reaction was carried out under this condition.

The remainder (110 parts) of the monomer composition (A) was added dropwise over 40 minutes, with the content in the reactor kept at 75° C. Polymerization was continued at 75° C. for 30 minutes. Then, 180 parts of the monomer composition (B) shown in Table 2 was added dropwise over 1 hour. The content in the reactor was kept at 75° C. for 1 hour to complete the polymerization reaction. After cooling, the reaction product was adjusted to pH 8.0 with 10% ammonia water and then diluted with deionized water to give a copolymer emulsion (S-1) containing 30% solids and having an average particle diameter of 0.055 μm. Incidentally, the glass transition point Tg_{A} of the polymer from the monomer composition (A) was 70° C., and the glass transition point Tg_{B} of the polymer from the monomer composition (B) was 101° C.

TABLE 2

| | |
|---|---|
| Monomer composition (A) | Monomer composition (B) |

| | | | |
|---|---|---|---|
| Styrene | 102 parts | Styrene | 144 parts |
| n-butyl acrylate | 16 parts | n-butyl acrylate | 9 parts |
| Methacrylic acid | 2 parts | Methacrylic acid | 27 parts |
| Total | 120 parts | Total | 180 parts |

### Preparation Example 2

Preparation Example 1 was repeated except that the monomer compositions were changed as shown in Table 3. Thus, there was obtained a copolymer emulsion (S-2) containing 30% solids and having an average particle diameter of 0.075 μm. Incidentally, the glass transition point Tg_{A} of the polymer from the monomer composition (A) was 80° C., and the glass transition point Tg_{B} of the polymer from the monomer composition (B) was 97° C.

TABLE 3

| | |
|---|---|
| Monomer composition (A) | Monomer composition (B) |

| | | | |
|---|---|---|---|
| Styrene | 102 parts | Styrene | 144 parts |
| Ethyl acrylate | 14 parts | Ethyl acrylate | 4 parts |
| Acrylic acid | 4 parts | Methyl methacrylate | 11 parts |
| | | Acrylic acid | 21 parts |
| Total | 120 parts | Total | 180 parts |

### Preparation Example 3

Preparation Example 1 was repeated except that the monomer compositions were changed as shown in Table 4. Thus, there was obtained a copolymer emulsion (S-3) containing 30% solids and having an average particle diameter of 0.090 μm. Incidentally, the glass transition point Tg_{A} of the polymer from the monomer composition (A) was 40° C., and the glass transition point Tg_{B} of the polymer from the monomer composition (B) was 120° C.

TABLE 4

| | |
|---|---|
| Monomer composition (A) | Monomer composition (B) |

| | | | |
|---|---|---|---|
| Styrene | 78 parts | Styrene | 139 parts |
| Ethyl acrylate | 34 parts | Methacrylic acid | 32 parts |
| Methacrylic acid | 2 parts | Acrylamide | 9 parts |
| Acrylamide | 6 parts | | |
| Total | 120 parts | Total | 180 parts |

### Preparation Example 4

Preparation Example 1 was repeated except that the monomer compositions were changed as shown in Table 5 and the emulsifier was replaced by aryllaurylsulfosuccinate diester sodium salt. Thus, there was obtained a copolymer emulsion (S-4) containing 30% solids and having an average particle diameter of 0.035 μm. Incidentally, the glass transition point Tg_{A} of the polymer from the monomer composition (A) was 65° C., and the glass transition point Tg_{B} of the polymer from the monomer composition (B) was 101° C.

TABLE 5

| Monomer composition (A) | | Monomer composition (B) | |
|---|---|---|---|
| Styrene | 86 parts | Styrene | 137 parts |
| n-butyl acrylate | 19 parts | n-butyl acrylate | 11 parts |
| Methyl methacrylate | 10 parts | Methacrylic acid | 32 parts |
| Methacrylic acid | 5 parts | | |
| Total | 120 parts | Total | 180 parts |

### Preparation Example 5

The same reactor as used in Preparation Example 1 was charged with 490 parts of deionized water and 10 parts of the emulsified product of the monomer composition (A) shown in Table 6. The content in the reactor was heated to 70° C. under a nitrogen stream. The reactor was supplied with 10 parts of an aqueous solution containing 2.3 parts of ammonium persulfate in deionized water, with the content in the reactor kept stirred at 70° C. The polymerization reaction was carried out under this condition.

The remainder (250 parts) of the monomer composition (A) was added dropwise over 1 hour, with the content in the reactor kept at 70° C. Polymerization was continued at 70° C. for 30 minutes. Then, 390 parts of the emulsified product of the monomer composition (B) shown in Table 6 was added dropwise over 1.5 hours. The content in the reactor was kept at 70° C. for 1 hour to complete the polymerization reaction. After cooling, the reaction product was adjusted to pH 7.0 with 10% sodium hydroxide solution and then diluted with deionized water to give a copolymer emulsion (S-5) containing 40% solids and having an average particle diameter of 0.130 μm. Incidentally, the glass transition point Tg_{A} of the polymer from the monomer composition (A) was 85° C., and the glass transition point Tg_{B} of the polymer from the monomer composition (B) was 112° C.

TABLE 6

| Emulsified product of | | Emulsified product of | |
|---|---|---|---|
| monomer composition (A) | | monomer composition (B) | |
| Styrene | 206 parts | Styrene | 309 parts |
| Ethyl acrylate | 30 parts | Methyl methacrylate | 23 parts |
| Methacrylic acid | 15 parts | Methacrylic acid | 45 parts |
| Polyoxyethylene | 9 parts | Polyoxyethylene (n = 10) | 13 parts |
| (n = 10) | | nonylarylphenyl ether | |
| nonylarylphenyl | | sulfate ester | |
| ether sulfate ester | | | |
| Total | 260 parts | Total | 390 parts |

### Preparation Example 6

Preparation Example 1 was repeated except that the monomer compositions were changed as shown in Table 7. Thus, there was obtained a copolymer emulsion (S-6) containing 30% solids and having an average particle diameter of 0.095 μm. Incidentally, the glass transition point Tg_{A} of the polymer from the monomer composition (A) was 101° C., and the glass transition point Tg_{B} of the polymer from the monomer composition (B) was 70° C.

TABLE 7

| | |
|---|---|
| Monomer composition (A) | Monomer composition (B) |

| | | | |
|---|---|---|---|
| Styrene | 96 parts | Styrene | 153 parts |
| n-butyl acrylate | 6 parts | n-butyl acrylate | 23 parts |
| Methacrylic acid | 18 parts | Methacrylic acid | 4 parts |
| Total | 120 parts | Total | 180 parts |

### Referential Preparation Example 1

The same reactor as used in Preparation Example 1 was charged with 641 parts of deionized water, 9 parts of polyoxyethylene (n=5) lauryl ether sulfate ester sodium salt (as an emulsifier), and 10 parts of the monomer composition shown in Table 8. The content in the reactor was heated to 75° C. under a nitrogen stream. The reactor was supplied with 10 parts of an aqueous solution containing 1.5 parts of ammonium persulfate in deionized water, with the content in the reactor kept stirred at 75° C. The polymerization reaction was carried out under this condition.

The remainder (290 parts) of the monomer composition was added dropwise over 1 hour and 40 minutes, with the content in the reactor kept at 75° C. Polymerization was continued at 75° C. for 1 hour at 75° C. to complete the polymerization reaction. After cooling, the reaction product was adjusted to pH 8.0 with 10% ammonia water and then diluted with deionized water to give a copolymer emulsion (H-1) containing 30% solids and having an average particle diameter of 0.050 μm and also having a glass transition point of 88° C.

TABLE 8
Monomer composition

| | |
|---|---|
| Styrene | 246 parts |
| Methyl methacrylate | 24 parts |
| Methacrylic acid | 30 parts |
| Total | 300 parts |

### Referential Preparation Example 2

Preparation Example 1 was repeated except that the monomer compositions were changed as shown in Table 9. Thus, there was obtained a copolymer emulsion (H-2) containing 30% solids and having an average particle diameter of 0.060 μm. Incidentally, the glass transition point Tg_{A} of the polymer from the monomer composition (A) was 85° C., and the glass transition point Tg_{B} of the polymer from the monomer composition (B) was 89° C.

TABLE 9

| Monomer composition (A) | | Monomer composition (B) | |
|---|---|---|---|
| Styrene | 103 parts | Styrene | 76 parts |
| n-butyl acrylate | 10 parts | n-butyl acrylate | 14 parts |
| Methacrylic acid | 7 parts | Methyl methacrylate | 76 parts |
| | | Methacrylic acid | 14 parts |
| Total | 120 parts | Total | 180 parts |

### Referential Preparation Example 3

Preparation Example 1 was repeated except that the monomer compositions were changed as shown in Table 10. Thus, there was obtained a copolymer emulsion (H-3) containing 30% solids and having an average particle diameter of 0.055 μm. Incidentally, the glass transition point Tg_{A} of the polymer from the monomer composition (A) was 89° C., and the glass transition point Tg_{B} of the polymer from the monomer composition (B) was 85° C.

TABLE 10

| Monomer composition (A) | | Monomer composition (B) | |
|---|---|---|---|
| Styrene | 50 parts | Styrene | 155 parts |
| n-butyl acrylate | 10 parts | n-butyl acrylate | 14 parts |
| Methyl methacrylate | 50 parts | Methacrylic acid | 11 parts |
| Methacrylic acid | 10 parts | | |
| Total | 120 parts | Total | 180 parts |

### Referential Preparation Example 4

Referential Preparation Example 1 was repeated except that the monomer composition was changed as shown in Table 11. Thus, there was obtained a copolymer emulsion (H-4) containing 30% solids and having an average particle diameter of 0.050 μm and also having a glass transition point of 70° C.

TABLE 11
Monomer composition

| | |
|---|---|
| Styrene | 102 parts |
| n-butyl acrylate | 16 parts |
| Methacrylic acid | 2 parts |
| Total | 120 parts |

### Referential Preparation Example 5

Referential Preparation Example 1 was repeated except that the monomer composition was changed as shown in Table 12. Thus, there was obtained a copolymer emulsion (H-5) containing 20% solids and having an average particle diameter of 0.050 μm and also having a glass transition point of 101° C.

TABLE 12
Monomer composition

| | |
|---|---|
| Styrene | 144 parts |
| n-butyl acrylate | 9 parts |
| Methacrylic acid | 27 parts |
| Total | 180 parts |

The above-mentioned Processes and Referential Processes gave the copolymer emulsions whose monomer composition, glass transition point, and average particle diameters are summarized in Table 13. Incidentally, the average particle diameter was measured with an electrophretic light scattering spectrophotometer (Model ELS-800, from Otsuka Electronics Co., Ltd.).

TABLE 13

| | Designation | | | | | | Glass | Average |
|---|---|---|---|---|---|---|---|---|
| | of | | Monomer composition (%) | | | | transition | particle |
| | copolymer | | Component | Component | Component | Component | point | diameter |
| | emulsion | | (a) | (b) | (c) | (d) | (° C.) | (μm) |
| Product | S-1 | (A) | St: 85 | n-BA: 13 | MAA: 2 | — | 70 | 0.055 |
| according | | (B) | St: 80 | n-BA: 5 | MAA: 15 | — | 101 | |
| to the | S-2 | (A) | St: 85 | EA: 12 | AA: 3 | — | 80 | 0.075 |
| present | | (B) | St: 80 | EA: 2 | AA: 12 | — | 97 | |
| invention | | | | MAA: 6 | | | | |
| | S-3 | (A) | St: 65 | EA: 28 | MAA: 2 | AAm: 5 | 40 | 0.090 |
| | | (B) | St: 77 | — | MAA: 18 | AAm: 5 | 120 | |
| | S-4 | (A) | St: 72 | n-BA: 16 | MAA: 4 | — | 65 | 0.035 |
| | | | | MAA: 8 | | | | |
| | | (B) | St: 76 | n-BA: 6 | MAA: 18 | — | 101 | |
| | S-5 | (A) | St: 82 | EA: 12 | MAA: 6 | — | 85 | 0.130 |
| | | (B) | St: 82 | MAA: 6 | MAA: 12 | — | 112 | |
| | S-6 | (A) | St: 80 | n-BA: 5 | MAA: 15 | — | 101 | 0.095 |
| | | (B) | St: 85 | n-BA: 13 | MAA: 2 | — | 70 | |
| Product for | H-1 | Homogenous | St: 82 | n-BA: 8 | MAA: 10 | — | 88 | 0.050 |
| comparison | | system | | | | | | |
| | H-2 | (A) | St: 86 | n-BA: 8 | MAA: 6 | — | 85 | 0.060 |
| | | (B) | St: 42 | n-BA: 8 | MAA: 8 | — | 89 | |
| | | | | MAA: 42 | | | | |
| | H-3 | (A) | St: 42 | n-BA: 8 | MAA: 8 | — | 89 | 0.055 |
| | | | | MAA: 42 | | | | |
| | | (B) | St: 86 | n-BA: 8 | MAA: 6 | — | 85 | |
| | H-4 | Homogenous | St: 85 | n-BA: 13 | MAA: 2 | — | 70 | 0.050 |
| | | system | | | | | | |
| | H-5 | Homogenous | St: 80 | n-BA: 5 | MAA: 15 | — | 101 | 0.050 |
| | | system | | | | | | |

In Table 13 above, abbreviations for components (a) to (d) stand for the following.
St: Styrene
n-BA: n-butyl acrylate
EA: Ethyl acrylate
MMA: Methyl methacrylate
2-EHA: 2-ethylhexyl acrylate
MAA: Methacrylic acid
AA: Acrylic acid
AAm: Acrylamide
   [3] Evaluation of Ink-Jet Printing Paper

### Example 1

The base paper was coated with a coating solution (shown below) for the undercoating layer by using an air knife coater in such a way that the dry weight was 15 g/m² after drying. The undercoating layer was coated with another coating solution (shown below) for the outermost part of the coating layer by using a roll coater. Immediately after coating, the coated paper was pressed against a mirror-finished drum kept its surface at 80° C. After drying, the coated paper was released from the drum. Thus there was obtained an ink-jet printing paper of glossy type. The amount of the coating layer was 10 g/m² on solids basis.

[Coating Solution for the Undercoating Layer]

(17% solids; Parts means parts by weight on solids basis)

The coating solution was prepared from the following components.
Amorphous silica as a pigment: 100 parts “Finesil X-45” from Tokuyama Corporation, having a specific surface area of 340 m²/g and an average secondary particle diameter of 4.5 μm.
Silyl-modified polyvinyl alcohol as an adhesive: 25 parts “R1130” from Kuraray Co., Ltd.
Dicyandiamide resin as a cationic resin: 5 parts “Neofix E-117” from Nicca Chemical Co., Ltd.
Cationic acrylamide resin as a cationic resin: 15 parts “Sumirez Resin SR1001” from Sumitomo Chemical Co., Ltd.
Fluorescent dye: 2 parts “Whitex BPSH” from Sumitomo Chemical.
Sodium polyphosphate as a dispersing agent: 0.5 parts
   [Coating Solution for the Outermost Part of the Coating Layer]

(12% solids; Parts means parts by weight on solids basis)

The coating solution was prepared from the following components.
Copolymer emulsion S-1 prepared in Preparation Example 1.
Anionic colloidal silica, 40% solids, pH 9.5, with an average particle diameter of 0.045 μm. (Referred to as Sample A hereinafter.)

The first and second components were mixed in a ratio of 1/9 (on solids basis), and the mixture was diluted with purified water to give a composition containing 30% solids. This composition (100 parts) was incorporated with 1 part of a copolymer of alkylvinylether-maleic acid derivative (as a thickening agent and a dispersing agent) and 2 parts of lecithin (as a release agent) to give the desired coating solution.

### Examples 2 to 5

The same procedure as in Example 1 was repeated to give an ink-jet printing paper of glossy type, except that the mixing ratio of the copolymer emulsion and the colloidal silica (Sample A) was changed to 3/7, 5/5, 7/3, and 9/1, on solids basis.

### Examples 6 to 10

The same procedure as in Example 1 was repeated to give an ink-jet printing paper of glossy type, except that the copolymer emulsion S-1 and anionic colloidal silica, 40% solids, pH 9.5, with an average particle diameter of 0.033 μm (referred to as Sample B hereinafter) were used.

### Comparative Examples 1 and 2

The same procedure as in Example 1 was repeated to give an ink-jet printing paper of glossy type, except that the coating solution for the outermost part of the coating layer was prepared from anionic colloidal silica alone.

The samples of ink-jet printing papers obtained in Examples 1 to 10 and Comparative Examples 1 and 2 were examined for aptitude for ink-jet printing (such as solid area uniformity, feathering, and print density), gloss, surface strength, feedability, etc. by actual printing with an ink-jet printer (Model PM-750C, from Seiko Epson Corporation). The results are shown in Table 14.

TABLE 14

| | Coating solution | | | | | | | | |
|---|---|---|---|---|---|---|---|---|---|
| | | | Mixing ratio | Results of evaluation | | | | | |
| | Copolymer | Colloidal | (on solids | Solid area | | Print | | Surface | |
| | emulsion | silica | basis) | uniformity | Feathering | density | Gloss | strength | Feedability |
| Example 1 | S-1 | Sample A | 1/9 | ⊚ | ⊚ | 2.05 | 70 | Δ | 9 |
| Example 2 | S-1 | Sample A | 3/7 | ⊚ | ⊚ | 1.95 | 70 | ◯ | 10 |
| Example 3 | S-1 | Sample A | 5/5 | ◯ | ⊚ | 1.90 | 75 | ◯ | 10 |
| Example 4 | S-1 | Sample A | 7/3 | ◯ | ◯ | 1.85 | 78 | ◯ | 10 |
| Example 5 | S-1 | Sample A | 9/1 | ◯ | ◯ | 1.83 | 83 | ◯ | 10 |
| Example 6 | S-1 | Sample B | 1/9 | ◯ | ⊚ | 2.00 | 70 | Δ | 9 |
| Example 7 | S-1 | Sample B | 3/7 | ⊚ | ⊚ | 1.89 | 70 | ◯ | 10 |
| Example 8 | S-1 | Sample B | 5/5 | ◯ | ⊚ | 1.84 | 75 | ◯ | 10 |
| Example 9 | S-1 | Sample B | 7/3 | ◯ | ◯ | 1.81 | 78 | ◯ | 10 |
| Example 10 | S-1 | Sample B | 9/1 | ◯ | ◯ | 1.81 | 83 | ◯ | 10 |
| Comparative | — | Sample A | — | ⊚ | ⊚ | 2.10 | 53 | X | 0 |
| Example 1 | | | | | | | | | |
| Comparative | — | Sample B | — | ⊚ | ⊚ | 2.00 | 54 | X | 0 |
| Example 2 | | | | | | | | | |

The items in Table 14 were rated according to the following criteria.

[1] Aptitude for Ink-Jet Printing

[1-1] Solid Area Uniformity

A solid printed area made from a mixture of cyan and magenta inks is visually examined for uniformity.
◯: Completely uniform
ο: Almost uniform; practically acceptable
Δ: Slightly uneven; barely acceptable
X: Remarkably uneven; unacceptable

[1-2] Feathering

Four solid areas are printed respectively with black, cyan, magenta, and yellow inks in such a way that they adjoin each other, and feathering at boundaries is visually observed.
◯: No feathering at all
ο: Very slight feathering without practical problems
Δ: Slight feathering with some problems
χ: Noticeable feathering with severe practical problems

[1-3] Print Density

A black solid area is measured for density by using a Macbeth illuminometer RD-914.

[2] Gloss

The surface gloss (750) is measured according to JIS Z8741.

[3] Surface Strength

A piece of mending tape (Scotch 810, 12 mm wide, 3 cm long) is stuck on the surface of ink-jet printing paper. After pressing evenly for 3 seconds, the tape is removed and the surface of the paper is visually observed.
ο: Very little peeling
ΔA: Partial peeling, without practical problems
X: Noticeable peeling, with severe practical problems
   [4] Feedability

Continuous printing is performed on ten sheets of the ink-jet printing paper, which are placed in an ink-jet printer (Model PM750C, from Seiko Epson Corporation), to see how many sheets can be fed without practical problems. (At least nine sheets should be fed continuously.)

As shown in Table 14, the samples of ink-jet printing paper in Examples 1 to 10 are superior in gloss, surface strength, and feedability to those in Comparative Examples. This is attributable to the outermost part of the coating layer which contains a specific copolymer (1) and colloidal silica (2). It is noted that the overall rating of the items examined is increased as the ratio of (1) to (2) is changed from 1/9 to 9/1, 3/7 to 7/3, or 3/7 to 5/5.

### Examples 11 to 20 and Comparative Examples 3 to 8

The same procedure as in Example 1 was repeated to prepare the coating solution for the outermost part of the coating layer, except that the copolymer emulsion and the anionic colloidal silica shown in Table 15 were used and their mixing ratio was changed to 3/7, on solids basis. Then, the same procedure as in Example 1 was repeated to give an ink-jet printing paper of glossy type. The results of evaluation are shown in Table 15.

### Example 21

The base paper was coated with the same undercoating solution as used in Example 1 by using an air knife coater in such a way that the dry weight was 15 g/m². The undercoating layer was coated with the same coating solution (for the outermost part of the coating layer) as used in Example 1 by using an air knife coater. After drying, the coated paper underwent hot supercalendering twice at a pressure of 50 kg and a surface temperature of 100° C. Thus there was obtained an ink-jet printing paper of glossy type. The amount of the surface coating layer was 10 g/m² on solids basis.

### Example 22

The base paper was coated directly with the same coating solution (for the outermost part of the coating layer) as used in Example 1 by using an air knife coater. After drying, the coated paper underwent hot supercalendering twice at a pressure of 50 kg and a surface temperature of 100° C. Thus there was obtained an ink-jet printing paper of glossy type. The amount of the surface coating layer was 10 g/m² on solids basis.

The samples of the ink-jet printing papers obtained in Examples 11 to 22 and Comparative Examples 3 to 8 were tested for printing performance by using the same printer as mentioned above. The results are shown in Table 15.

TABLE 15

| | Coating solution | | | | | | | | |
|---|---|---|---|---|---|---|---|---|---|
| | | | Mixing ratio | Results of evaluation | | | | | |
| | Copolymer | Colloidal | (on solids | Solid area | | Print | | Surface | |
| | emulsion | silica | basis) | uniformity | Feathering | density | Gloss | strength | Feedability |
| Example 11 | S-2 | Sample A | 3/7 | ⊚ | ⊚ | 1.95 | 70 | ◯ | 20 |
| Example 12 | S-3 | Sample A | 3/7 | ⊚ | ◯ | 1.95 | 70 | ◯ | 10 |
| Example 13 | S-4 | Sample A | 3/7 | ⊚ | ⊚ | 1.93 | 68 | ◯ | 10 |
| Example 14 | S-5 | Sample A | 3/7 | ◯ | ◯ | 1.93 | 70 | ◯ | 10 |
| Example 15 | S-6 | Sample A | 3/7 | ◯ | ◯ | 1.91 | 70 | ◯ | 10 |
| Example 16 | S-2 | Sample B | 3/7 | ⊚ | ⊚ | 1.90 | 70 | ◯ | 10 |
| Example 17 | S-3 | Sample B | 3/7 | ⊚ | ◯ | 1.90 | 70 | ◯ | 10 |
| Example 18 | S-4 | Sample B | 3/7 | ⊚ | ⊚ | 1.88 | 68 | ◯ | 10 |
| Example 19 | S-5 | Sample B | 3/7 | ◯ | ◯ | 1.88 | 70 | ◯ | 10 |
| Example 20 | S-6 | Sample B | 3/7 | ◯ | ◯ | 1.87 | 70 | ◯ | 10 |
| Example 21 | S-1 | Sample A | 1/9 | ⊚ | ⊚ | 1.95 | 66 | ◯ | 10 |
| Example 22 | S-1 | Sample A | 1/9 | ◯ | ◯ | 1.80 | 65 | ◯ | 10 |
| Comparative | H-1 | Sample A | 3/7 | Δ | ◯ | 1.80 | 68 | Δ | 2 |
| Example 3 | | | | | | | | | |
| Comparative | H-2 | Sample A | 3/7 | Δ | Δ | 1.70 | 65 | Δ | 2 |
| Example 4 | | | | | | | | | |
| Comparative | H-3 | Sample A | 3/7 | ◯ | ⊚ | 1.95 | 70 | ◯ | 1 |
| Example 5 | | | | | | | | | |
| Comparative | H-4 | Sample A | 3/7 | Δ | ◯ | 1.77 | 70 | Δ | 10 |
| Example 6 | | | | | | | | | |
| Comparative | H-5 | Sample A | 3/7 | ⊚ | ⊚ | 1.95 | 70 | ◯ | 1 |
| Example 7 | | | | | | | | | |
| Comparative | 50:50 | Sample A | 3/7 | ◯ | ◯ | 1.77 | 65 | Δ | 1 |
| Example 8 | mixture | | | | | | | | |
| | of H-4 | | | | | | | | |
| | and H-5 | | | | | | | | |

It is noted from Table 15 that the samples of ink-jet printing papers in Examples 11 to 22 are superior in printability, surface strength, and feedability to those in Comparative Examples 3 to 8 on account of the surface coating layer containing the specific copolymer (1) and the colloidal silica (2) according to the present invention.

The samples of ink-jet printing papers in Comparative Examples 6 to 8 are inferior in printability, surface strength, and feedability to those in Examples 11 to 22. This is because Comparative Example 6 used only the copolymer from (A) monomer as a component of S-1, Comparative Example 7 used only the copolymer from (B) monomer as a component of S-1, and Comparative Example 8 used in combination the copolymer from (A) monomer as a component of S-1 and the copolymer from (B) monomer as a component of S-1.

In Examples 21 and 22, cast coating is replaced by air knife coating followed by hot calendering. Nevertheless, the resulting ink-jet printing papers are superior in gloss, printability, and feedability so long as they have the surface layer containing the copolymer (1) and colloidal silica (2) specified in the present invention.

The ink-jet printing paper according to the present invention exhibits a high gloss (in both printed areas and unprinted areas), a high print density, a high ink absorptivity, a high image quality, and a good feedability, on account of the surface layer containing a specific copolymer and colloidal silica.

1. An ink-jet printing paper comprising a base paper and at least one coating layer formed on the base paper, wherein at least the outermost part of the coating layer contains a copolymer (1) and colloidal silica (2), said copolymer (1) being one which is obtained by polymerizing a monomer composition (A) in the first stage and copolymerizing a monomer composition (B) in the second stage, with the resulting polymer of the monomer composition (A) having a glass transition point of Tg_{A} and the resulting polymer of the monomer composition (B) having a glass transition point of Tg_{B} such that the difference between Tg_{A} and Tg_{B} is 5° C. or more, said monomer compositions (A) and (B) each being composed of at least either of two monomer compositions, each containing a monomer (a) defined below and/or a monomer (b) defined below, and a monomer (c) defined below.
(a) Styrene and/or α-methylstyrene.
(b) An alkyl ester of acrylic acid and/or alkyl ester of methacrylic acid represented by the 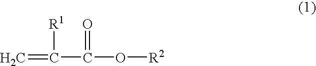
formula (1) below.
(where R¹ denotes a hydrogen atom or methyl group, and R² denotes a C₁₋₂₂ saturated or unsaturated linear or branched aliphatic hydrocarbon group.)
(c) An α,β-unsaturated carboxylic acid and/or salt thereof.

2. An ink-jet printing paper comprising a base paper and a surface layer formed on the base paper, wherein said surface layer contains a copolymer (1) and colloidal silica (2), said copolymer (1) being one which is obtained by polymerizing a monomer composition (A) in the first stage and copolymerizing a monomer composition (B) in the second stage, with the resulting polymer of the monomer composition (A) having a glass transition point of Tg_{A} and the resulting polymer of the monomer composition (B) having a glass transition point of Tg_{B} such that the difference between Tg_{A} and Tg_{B} is 5° C. or more, said monomer compositions (A) and (B) each being composed of at least either of two monomer compositions, each containing a monomer (a) defined below and/or a monomer (b) defined below, and a monomer (c) defined below.
(a) Styrene and/or α-methylstyrene.
(b) An alkyl ester of acrylic acid and/or alkyl ester of methacrylic acid represented by the 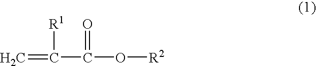
formula (1) below.
(where R¹ denotes a hydrogen atom or methyl group, and R² denotes a C₁₋₂₂ saturated or unsaturated linear or branched aliphatic hydrocarbon group.)
(c) An α,β-unsaturated carboxylic acid and/or salt thereof.

3. The ink-jet printing paper as defined claim 1 or 2, wherein said monomer composition (A) and/or said monomer composition (B) further contains a monomer (d) defined below.
(d) A monomer polymerizable with said monomers (a) to (c).

4. The ink-jet printing paper as defined in claim 1, wherein said copolymer is applied in the form of copolymer emulsion having an average particle diameter of 0.02 to 0.15 μm.

5. The ink-jet printing paper as defined in claim 1, wherein said colloidal silica is one which has an average particle diameter of 0.01 to 0.15 μm.

6. The ink-jet printing paper as defined in any of claims 1 to 5 claim 1, wherein the ratio of said copolymer (1) to said colloidal silica (2) is from 1/9 to 9/1 (by mass of solids).

7. The ink-jet printing paper as defined in claim 1, wherein said surface layer is one which is formed by casting.

8. The ink-jet printing paper as defined in claim 1, which has a surface gloss (75°) not smaller than 30% measured by the method conforming to JIS Z8741.
